(19) United States
(12) Patent Application Publication
(10) Pub. No.: US 2025/0337836 A1
(43) Pub. Date: Oct. 30, 2025

(54) SYSTEMS AND METHODS FOR BLOCKING VOICE CALLS AND MESSAGES

(71) Applicant: Verizon Patent and Licensing Inc., Basking Ridge, NJ (US)

(72) Inventors: Kashif Khan, Keller, TX (US); Shawn R. Pugh, Easton, PA (US); Daniel L. Walker, Wall, NJ (US); Danysel Barthelme, Frisco, TX (US); Ronald E. Collier, II, Arlington, TX (US)

(21) Appl. No.: 18/644,489

(22) Filed: Apr. 24, 2024

(51) Int. Cl. H04M 3/436; H04L 65/1076

(52) U.S. Cl. CPC H04M 3/436; H04L 65/1076

(57) ABSTRACT

A system may comprise a network device and a communication device. The communication device may be configured to: receive a request from a communication device to subscribe to a blocking list; subscribe the communication device to the blocking list; and send a network identifier that is associated with the blocking list. The communication device may be configured to: receive the network identifier from the network device; download the blocking list from a location identified by the network identifier; and block voice calls or messages that originate from a source identified by the blocking list.

### BACKGROUND INFORMATION

The IP Multimedia Subsystem (IMS) refers to an architectural framework designed to deliver multimedia communications services over Internet Protocol (IP) networks. The IMS has evolved as part of mobile networks, such as a Global System for Mobile Communications (GSM) network, to provide services beyond simple voice calls. Its current scope supports a wide range of networks, including fixed and mobile broadband networks.

### BRIEF DESCRIPTION OF THE DRAWINGS

FIG. 1 illustrates a system that is associated with blocking voice calls and messages, according to an implementation.

FIG. 2 illustrates an exemplary network environment in which a system described herein may be implemented, according to an implementation.

FIG. 3 depicts exemplary components of a system associated with blocking voice calls and messages, according to an implementation.

FIG. 4 shows exemplary messaging, in a system, between components for blocking voice calls, according to an implementation.

FIG. 5 shows exemplary messaging, in a system, between components for blocking messages, according to an implementation.

FIG. 6 shows example components of a lists database (DB), according to an implementation.

FIG. 7 shows example fields of an example peer table, according to an implementation.

FIG. 8 shows example messaging, in a system, between components for blocking nuisance calls, according to an implementation.

FIG. 9 shows example messaging, in a system, between components for reporting spam, according to an implementation.

FIG. 10 is a flow diagram of an example process for subscribing to blocking lists, according to an implementation.

FIGS. 11 and 12 depict example messaging, in a system, that are exchanged between components associated with subscribing to blocking lists, according to an implementation.

FIG. 13 depicts exemplary components of an exemplary network device according to an implementation.

### DETAILED DESCRIPTION OF EMBODIMENTS

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID) or another identifier.

The systems and methods described herein relate to blocking voice calls and messages. More specifically, the systems and methods relate to inspecting and making blocking decisions on incoming voice calls and messages in an Internet Protocol (IP) Multimedia Subsystem (IMS). The systems and methods may provide granular control over and bring visibility to entities trying to send unwanted communications.

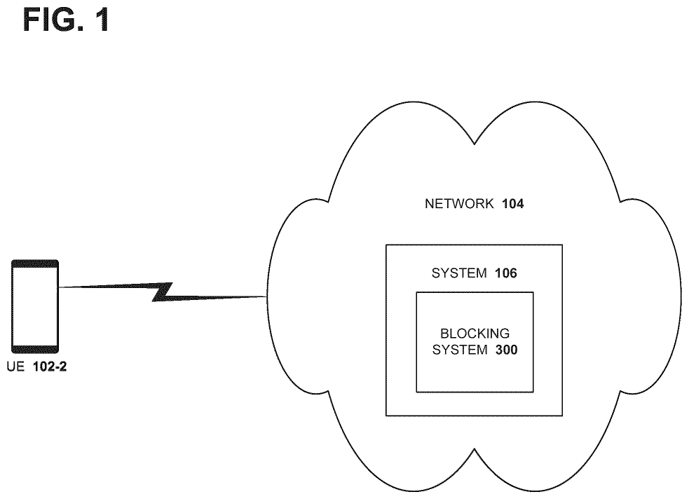

FIG. 1 illustrates a system 106 that is associated with blocking voice calls and messages according to an implementation. As shown, a User Equipment device (UE) 102-2 may connect to provider network 104 over a cellular link or a wireless local area network (WLAN) to receive voice calls and messages from various devices which may be either directly attached to network 104 or may be included in/attached to networks that are peered with network 104. Some of these devices may inject unwanted calls and messages into network 104. To prevent these communications from reaching UE 102, system 106 includes a blocking system 300.

Blocking system 300 may have the ability to a create static or dynamic lists of blocked numbers and network addresses and provide them to other components within system 106. Each list may specify whether the list is to be applied nationally/globally or to specific geographical regions. In addition, blocking system 300 may allow users to update their nuisance caller lists and transfer the nuisance caller lists to a user profiles stored in system 106, without querying another system internal to network 104. In some implementations, blocking system 300 may include Artificial Intelligence (AI)/Machine Learning (ML)-assisted components for reporting the unwanted communications to other network components, users, and/or network operators.

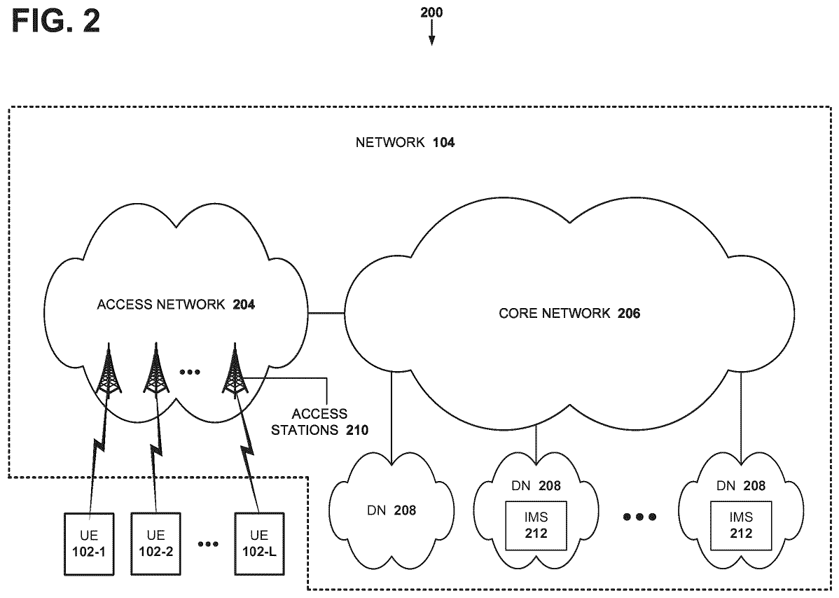

FIG. 2 illustrates an exemplary network environment 200 in which system 106 may be implemented. As shown, network environment 200 may include UEs 102-1 through 102-L (collectively referred to as UEs 102 and generically as UE 102), an access network 204, a core network 206, and data networks (DNs) 208 (generically as data network 208). Access network 204, core network 206, and data networks 208 may be part of cellular network 104.

UE 102 may include a wireless communication device, capable of Fifth Generation (5G) cellular communication, Fourth Generation (4G) cellular communication (e.g., Long-Term Evolution(LTE) communication), WI-FI communication, Bluetooth® communication, etc. Examples of UE 102 include: a smart phone; a tablet device; a wearable computer device (e.g., a smart watch); a global positioning system (GPS) device; a laptop computer; a media playing device; a portable gaming system; and an Internet-of-Things (IoT) device. In some implementations, UE 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices.

After UE 102 registers at network 104, UE 102 may initiate a session with network 104 to make a call and/or send a message. More specifically, UE 102 and core network 206 may establish a protocol data unit (PDU) session or a packet data network (PDN) session with core network 206 and create flows between an application (e.g., messaging application, phone application, etc.) running on UE 102 and an application server running on network 104. Via the application server, UE 102 may receive calls or messages from other UEs 102 attached to network 104. These calls and messages may include unwanted communications. Upon receipt of unwanted calls or messages, UE 102 may report them to network 104 so that network 104 may block future unwanted calls and messages that originate from the same sources from reaching UE 102 or other UEs 102.

Access network 204 may include a 5G New Radio (NR) network, an LTE radio network, an LTE-Advanced radio network, or another type of radio network. These networks may comprise many central units (CUs), distributed units (DUs), radio units (RUs), and access stations, which are illustrated in FIG. 2 as access stations 210 for establishing and maintaining an over-the-air broadband channels with UEs 102. Each access station 210 may include a 4G, 5G, or another type of base station (e.g., eNB, gNB, etc.) that comprises one or more radio frequency (RF) transceivers. In some implementations, access station 210 may be part of an evolved Universal Mobile Telecommunications Service (UMTS) Terrestrial Network (eUTRAN).

Access network 204 may include, in addition to radio access networks (RANs), other networks via which UE 102 may access core network 206. For example, access network 204 may include various IP networks, such as a WLAN. A WLAN may operate in accordance with various Institute of Electrical and Electronics Engineering (IEEE) 802.11 protocols. A WLAN may include devices that use radio waves to communicate in, for example, 2.4 GHz band and/or 5 GHz band, as well as other wired network devices, such as Ethernet devices.

Core network 206 may include one or more devices and network components for providing communication services to UEs 102. For example, core network 206 may permit UEs 102 to attach to network 104, establish sessions with devices in network 104, and/or receive services from network 104 (e.g., receive content, access the Internet, conduct video conferences with other UEs 102 attached to network 104). To deliver services, core network 206 may interface with other networks, such as data networks 208. To render these services and to perform the core functions of network 104, core network 206 may include 5G core network components, 4G core network components, and/or another type of core network components.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. Each data network 208 may include and/or be connected to a local area network (LAN), a wide area network (WAN), a metropolitan area network (MAN), an autonomous system on the Internet, an optical network, a cable television network, a satellite network, another wireless network (e.g., a Code Division Multiple Access (CDMA) network, a general packet radio service (GPRS) network, and/or an LTE network), a telephone network (e.g., the Public Switched Telephone Network (PSTN) or a cellular network), an intranet, an ad hoc network, or a combination of networks.

As further shown, data networks 208 may include one or more IMS 212. IMS 212 may deliver multimedia communications services over IP networks. IMS 212 may support a wide range of networks, including fixed and mobile broadband networks. In some implementations, IMS 212 may include Session Initiation Protocol (SIP) networks that play a role in establishing, managing, and terminating multimedia sessions. Such sessions may comprise voice, video, text messages, and other types of multimedia communications across IP networks. The SIP network may include at least a portion of system 106 for making blocking decisions on incoming voice calls and messages. System 106 may provide granular control over unwanted communications.

For clarity, FIG. 2 does not show all components that may be included in network environment 200 (e.g., routers, bridges, additional networks, additional access stations 210, data centers, portals, etc.). Depending on the implementation, network environment 200 may include additional, fewer, different, or different components than those illustrated in FIG. 2. Furthermore, in different implementations, the configuration of network environment 200 may be different.

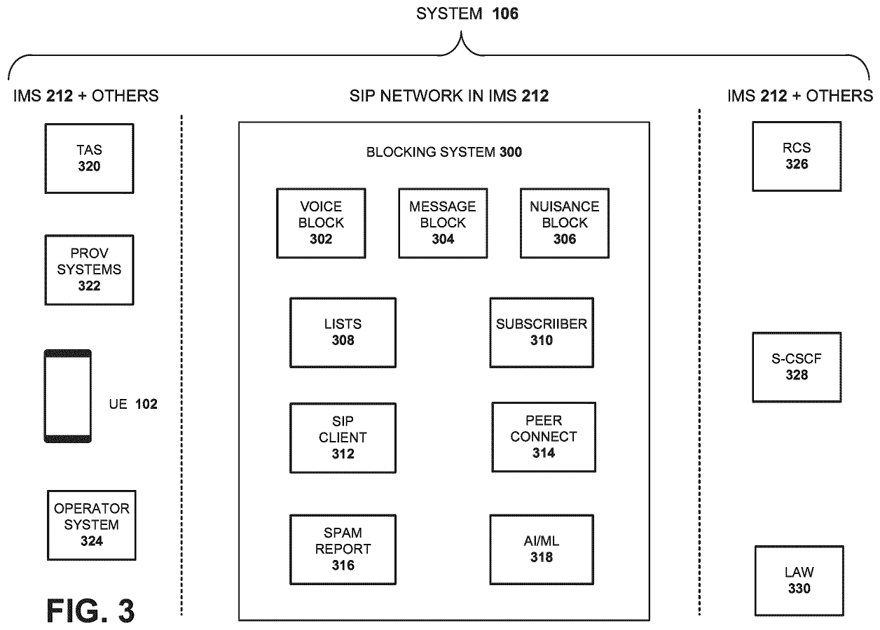

FIG. 3 depicts exemplary components, of system 106, according to an implementation. As shown, system 106 may include blocking system 300 within an SIP network included in IMS 212. Blocking system 300 in turn may comprise a voice block 302, a message block 304, a nuisance block 306, a lists database (DB) 308, a subscriber service 310, an SIP client service 312, a peer connect service 314, a spam report service 316, and an artificial intelligence (AI)/machine learning (ML) service 318. In addition, system 106 may include other components of IMS 212 and network 104, such as a Telephony Application Server (TAS) 320, provisioning systems 322, one or more of UE 102, an operator system 324, a Rich Communication Services (RCS) 326, a Serving-Call Session Control Function (S-CSCF) 328, and a law service 330. Depending on the implementation, system 106 may include additional, fewer, different, or a different arrangement of components than those depicted in FIG. 3.

Voice block 302 may comprise an interface between components of blocking system 300 and TAS 320. For example, voice block 302 may relay lists of blocking lists associated with calls to be blocked from subscriber service 310 to TAS 320. Message block 304 may comprise an interface between components of blocking system 300 and RCS 324. For example, message 304 may relay lists of blocking lists associated with messages to be blocked to RCS 326. Both voice block 302 and message block 304 may permit components (e.g., TAS 320 or RCS 326) to subscribe to services at voice block 302/message block 304 to receive notification related to blocking lists (e.g., updates).

Nuisance block 306 may interface with UEs 102 to receive call numbers or network addresses of the sources of nuisance communications and transfer them to user profiles stored in provisioning systems 322 within system 106, without querying another system internal to network 104. Provisioning systems 322 may store the nuisance caller numbers in subscription profiles that are associated with the UEs 102. TAS 320 or RCS 326 may access the subscription profiles on provisioning systems 322 to obtain a list of nuisance caller numbers and network addresses and use them to block calls and messages that originate from the caller numbers and/or network addresses.

Lists DB 308 may store blocking lists. Each blocking list may include numbers and/or network addresses of the source of calls/messages that are to be blocked. In addition, lists dB 308 may store a list of peers (e.g., devices or entities in blocking system 300) and peer subscription lists. Subscriber service 310 may relay or distribute information pertaining to blocking lists stored at lists DB 308 to peers in system 300 or notify subscribed peers of new blocking lists and/or updates to the blocking lists. Upon receipt of notifications from subscriber service 310 via voice block 302 or message block 304, the peers (e.g., TAS 320, RCS 326, etc.) may access lists DB 308 to access the blocking lists or updates. SIP client service 312 may interface with S-CSCF 328 (e.g., as an SIP client) and review IMS-Short Messaging Service (SMS) messages, sessions and/or another type of session communications.

Peer connect service 314 may permit components in blocking system 300 to interact with some components that are external to blocking system 300, such as operator system 324 or law system 330. For example, operator system 324 may place a blocking lists in lists DB 308 via peer connect service 314. Spam report service 316 may interface with UEs 102 and receive, from UEs 102, reports of spam and data which indicates sources of the spam (e.g., a call number, an IP address, etc.). The user of UE 102, for example, may input spam related information via UE 102 and provide the information to spam report service 316. Spam report service 316 may provide the information to other components of system 106, such as AI/ML service 318. AI/ML service 318 may collect reports on spam and correlate the reports to possible offenders (e.g., particular call numbers or network addresses that may be the sources of spams). AI/ML service 318 may provide the numbers or the network addresses of the likely offenders for temporary blocking in, for example, particular geographical regions.

TAS 320 may process call signaling to establish, manage, and/or terminate calls between UEs 102. For example, TAS 320 may provide call forwarding, call waiting, voicemail, video or teleconferencing, and interactive voice response (IVR) services. In rendering its services TAS 320 may use data from other network components, such as provisioning systems 322 (e.g., obtain lists of nuisance caller lists in user profiles). In addition, TAS 320 may support compliance with regulatory or legal requirements, such as emergency calling requirements, safety requirements, and/or lawful intercept requirements. TAS 320 may use standard protocols, such as SIP for signaling, Diameter for security, and/or other protocols for charging, policy control, and other functions. In one implementation, TAS 320 may access or receive blocking lists from lists DB 308, as well as change notifications and/or addresses (e.g., Universal Resource Identifiers (URIs)) of the blocking lists from subscriber service 310 via voice block 302. Upon receipt of blocking lists, TAS 320 may block or prevent voice calls from particular numbers (e.g., MSISDN) or network addresses in the blocking lists.

Provisioning systems 322 may provision subscription data or part of subscription data associated with UEs 102 to components in IMS 212. Examples of provisioning systems 322 include a Home Subscriber Server (HSS), a Unified Data Management (UDM), and/or a Unified Data repository (UDR) that store subscription profiles. In one implementation, provisioning systems 322 may receive a list of nuisance call/message sources reported by UE 102 from nuisance block 306 and store the list in the subscription profile associated with the UE 102. Additionally, provisioning systems 322 may provide the list to TAS 320 or RCS 326 for call/message blocking. Operator system 324 may permit network operators to provide, validate, and/or modify offender sources identified at AI/ML service 318.

RCS 326 may provide text, video, audio, and/or other types of communication services. In one implementation, RCS 326 may receive blocking lists from message block 304 and apply the blocking lists to SIP-invites and SIP-messages, and thus, prevent messages (or other communications) from the sources identified in the lists. In some implementations, RCS 326 may obtain nuisance caller lists from provisioning systems 322 to block nuisance messages, in a manner similar to that described above for TAS 320.

S-CSCF 328 may initiate, manage, and/or terminate sessions in IMS 212, including the sessions associated with RCS 326. In one implementation, S-CSCF 328 may provide SIP messages (e.g., those associated with RCS 326 and to which blocking lists are to be applied) to SIP client service 312 for inspection. Law service 332 may provide blocking lists that may be associated with law enforcement to lists DB 308 via subscriber service 310.

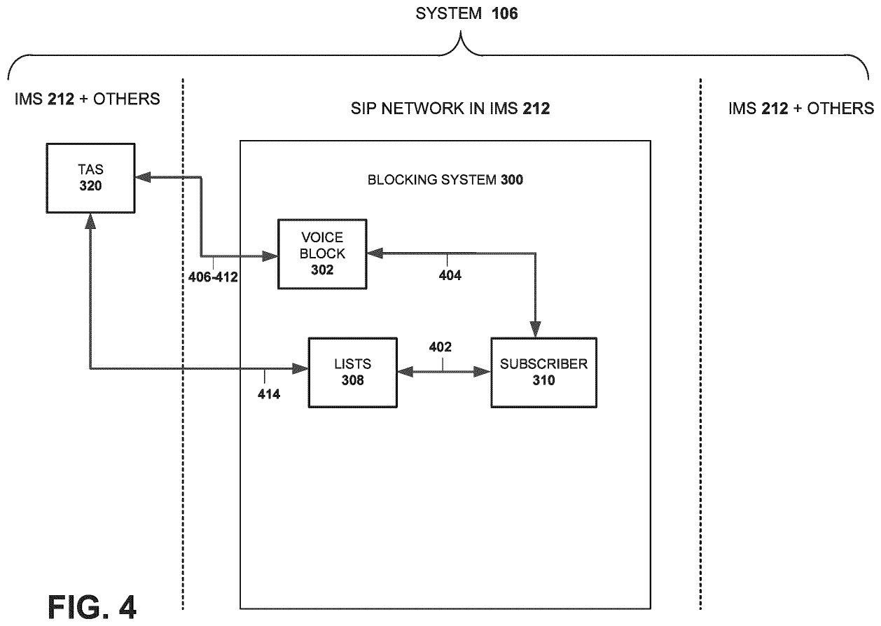

FIG. 4 shows exemplary messaging between components, in system 106, which are associated with blocking voice calls, according to an implementation. In FIG. 4, voice block 302, lists DB 308, subscriber service 310, and TAS 320 may exchange lists and/or signals that are associated with blocking voice calls. As shown, subscriber service 310 may obtain addresses (e.g., URIs) of the blocking lists in lists DB 308 via messages 402 and send messages 404 to relay the addresses to voice block 302. Later, TAS 320 may send a subscription query 406 to voice block 302. In response to the subscription query, voice block 302 may provide a message 408 which conveys the identities of, of the blocking lists, received from subscriber service 310. TAS 320 may then subscribe to one or more of the blockings lists by sending one or more messages 410 to voice block 302. Voice block 302 may provide notifications 412, to indicate any updates to the subscribed blocking lists or the availability of the blocking lists. When notified of availability of or updates to the subscribed blocking lists, TAS 320 may exchange messages 414 with lists DB 308 to obtain the blocking lists or the updates. TAS 320 may then apply the obtained blocking lists to block or disallow the voice calls originating from the sources specified in the blocking lists (e.g., telephone numbers or MSISDNs).

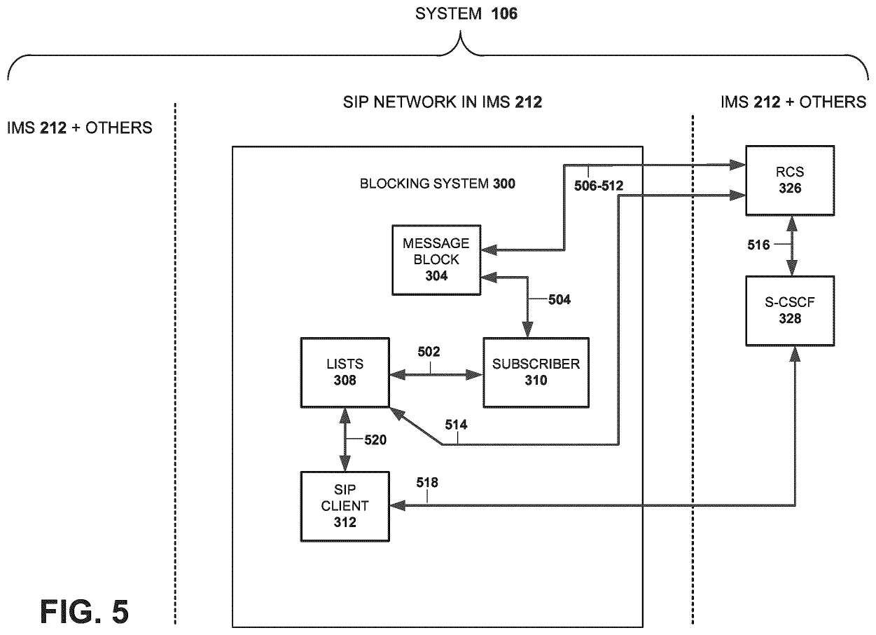

FIG. 5 shows exemplary messaging between components, in system 106, which are associated with blocking messages. In FIG. 5, message block 304, lists DB 308, subscriber service 310, and RCS 326 may exchange lists and/or signals that are associated with blocking messages. As shown, subscriber service 310 may obtain addresses (e.g., URIs) of the blocking lists in lists DB 308 via messages 502 and send messages 504 to relay the addresses to message block 304. Later, RCS 326 may send a subscription query 506 to message block 304. In response to the query, message block 304 may provide to RCS 326 a message 508 which conveys the identities of the blocking lists, received from subscriber service 310. RCS 326 may then subscribe to one or more of the blockings lists by sending one or more messages 510 to message block 304. Message block 304 may provide notifications 512 to indicate any updates to the subscribed blocking lists or the availability of the lists. When notified of availability of or updates to the subscribed blocking lists, RCS 326 may exchange messages 514 with lists DB 308 to obtain the blocking lists or the updates. RCS 326 may then apply the obtained blocking lists to S-CSCF 328 (send messages 516) to block or disallow messages or sessions originating from the sources specified in the blocking lists (e.g., telephone numbers, MSISDNS, network addresses, etc.). SIP client 312 may obtain messages or parameters associated with new sessions/messages and/or blocked sessions/messages from S-CSCF 328 via messages 518 and cross-check the sources of the sessions/messages against the blocking lists obtained from lists DB 308.

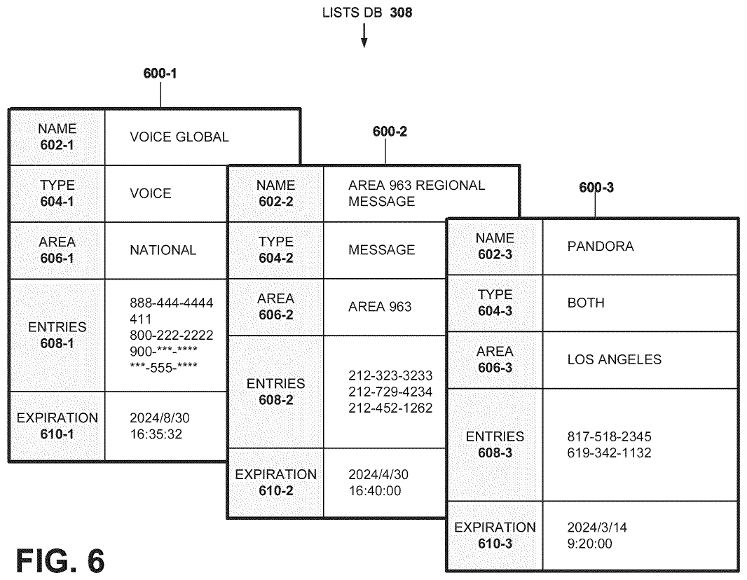

FIG. 6 shows example components of lists DB 308, according to an implementation. As shown, lists DB 308 may include blocking lists 600, three of which are depicted as blocking list 600-1, blocking list 600-2, and 600-3 (generically referred to as list 600). Each list 600 may include a number of fields, such as a name field 602, a type field 604, an area field 606, entries field 608, and an expiration field 610. Depending on the implementation, each blocking list 600 may include additional, fewer, or different fields than those depicted.

Name field 602 may store a name (e.g., an alphanumeric string) that uniquely identifies blocking list 600. For example, name fields 602 in lists 600-1 through 600-3 stores, respectively, the names “voice global,” “area 963 regional message,” and “pandora.” Type field 604 may store an indication of whether the blocking list 600 is for blocking voice calls or messages. For example, type fields 604 for lists 600-1, 600-2, and 600-3 indicate voice calls, messages, and both voice calls and messages. Area field 606 may indicate the region in which calls or messages identified by the list 600 may be blocked. For example, blocking lists 600-1. 600-2, and 600-3 may be applied, respectively, nationally, in area 963 (e.g., in an area associated with area code 963), and in Los Angeles. Entries field 608 may include the calling numbers (e.g., MSISDNs) or another type of identifier (e.g., an IP address) associated with the source of the call/messages.

Expiration field 610 may store the time at which the list 600 may no longer be used to block voice calls or messages, depending on whether the list 600 is a static or a dynamic list. If a list 600 has been dynamically generated, expiration field 610 may specify a definite time (e.g., from the current time, 11 hours, 2 hours, 10 hours, 20 hours, a week, a month, a year, etc.). If a list 600 is a static list, the list 600 may be applicable indefinitely and/or until expiration field 610 is changed.

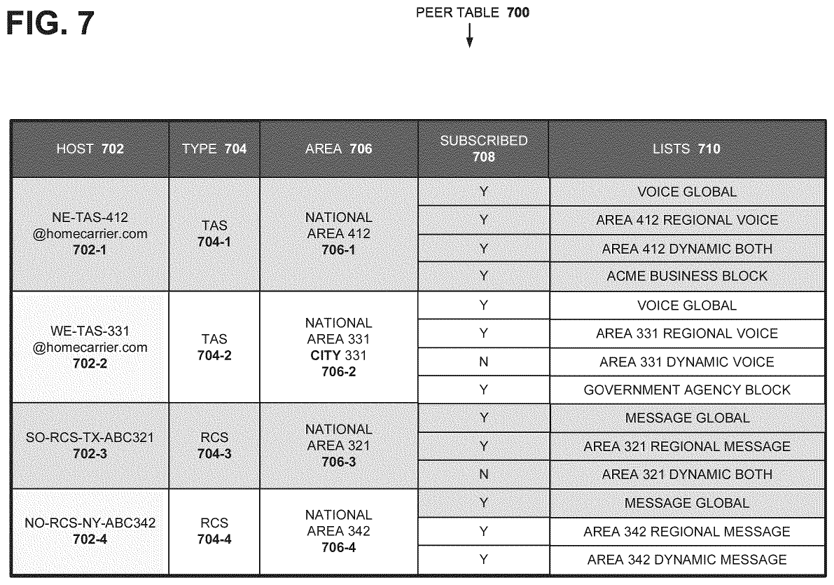

FIG. 7 shows example fields of an example peer table 700, according to an implementation. Voice block 302 and message block 304 may each include peer table 700. Peer table 700 may identify authorized peers (e.g., TAS 320, RCS 326, etc.) that are permitted to receive blocking lists 600 from blocking system 300. As shown, peer table 700 may include records, where each record includes a host field 702, a type field 704, an area field 706, a subscribed field 708, and a lists field 710. Depending on the implementation, peer table 700 may include records with additional, fewer, different, or a different arrangement of fields than those illustrated in FIG. 7.

Host field 702 may store a unique identifier (e.g., a hostname) for an application or a server that is allowed to receive blocking lists 600. For example, fields 702-1 through 702-4 specify the names of different TAS servers and RCS servers that may receive blocking lists 600. Type field 704 may identify whether the application/server identified by host field 702 includes a particular kind of application or server. For example, fields 704-1 through 704-4 indicate that the application or server identified at field 702 is a TAS or an RCS. In other implementations, type field 704 may indicate a type of application or server other than TAS or RCS. Area field 706 may indicate the geographical region in which the host may be located.

Subscribed field 708 may indicate, for each of the blocking lists 600 identified in lists field 710, whether the host is subscribed to receive the blocking list 600 or information pertaining to the list 600 (e.g., updates). For example, the host identified by host field 702-1 is subscribed to the following blocking lists 600: “voice global,” area 412 regional voice,” “area 412 dynamic both,” and “ACME Business Block” (e.g., indicated as Y for each of the lists in the corresponding subscribed fields 708). When a host identified by host field 702 is subscribed to a particular list identified in lists field 710, voice block 302 or message block 304 using peer table 700 may notify the subscribed host regarding any changes to the list. Upon receipt of the notification, the host may access the list in lists DB 308. Lists field 710 may identify blocking lists that the host is permitted to access. For example, the host identified by host field 702-1 may access the following blocking lists identified by lists field 710: “voice global,” area 412 regional voice,” “area 412 dynamic both,” and “ACME Business Block”

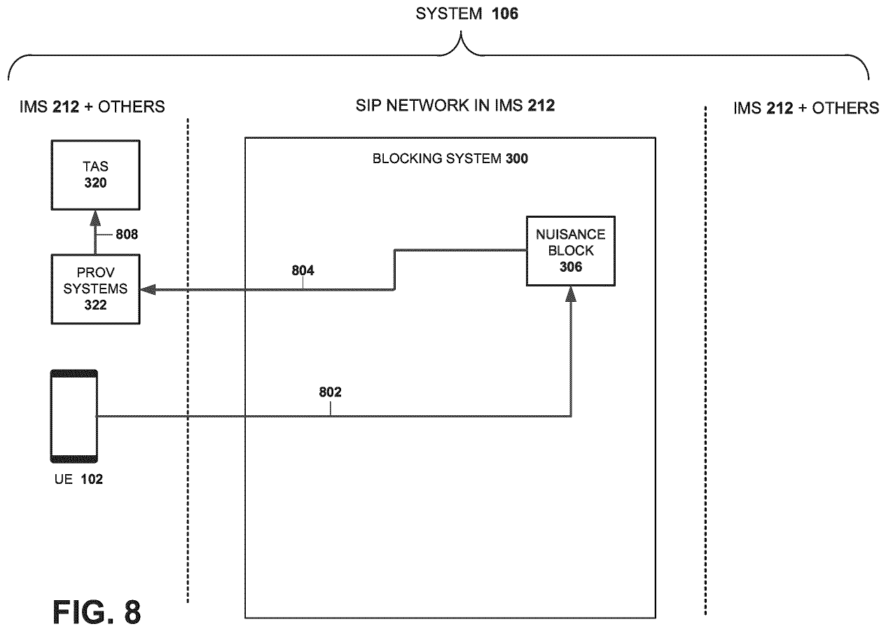

FIG. 8 shows exemplary messaging between components, in system 106, which are associated with blocking nuisance calls, according to an implementation. In FIG. 8, nuisance block 306, TAS 320, and provisioning systems 322 may exchange messages that are associated with blocking nuisance calls. As shown, nuisance block 306 may obtain, from UE 102, addresses (e.g., URIs) or call number of nuisance calls received at UE 102 via messages 802. For example, a user of UE 102 may provide a number of a nuisance caller via a browser. When nuisance block 306 receives the number or network address of the nuisance caller, nuisance block 306 may send a request 804 to provisioning system 322 to insert the nuisance caller ID (caller number or the network address) in the nuisance caller list in the subscription profile/data associated with the user of UE 102. For example, assuming that provisioning systems 322 is implemented as a UDM or an HSS, nuisance block 306 may send the nuisance caller number via an Application Programming Interface (API) to the UDM/HSS and have the UDM/HSS include the nuisance caller number in the nuisance caller list in the subscription profile. Later, TAS 320 may access or receive the nuisance caller number 808 from provisioning systems 322. TAS 320 may then block any calls from the caller number from reaching UE 102. Although not shown in FIG. 8, in some implementations, RCS 326 may access provisioning systems 322 to obtain nuisance caller lists for UEs 102 to block nuisance messages in a manner similar to that described for TAS 320.

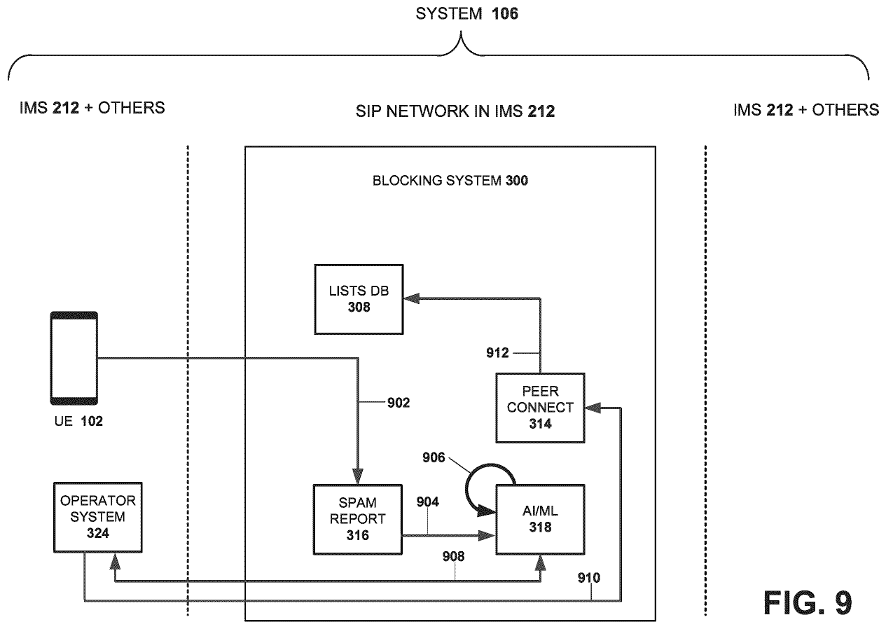

In some implementations, when nuisance block 306 obtains a call number or a network address of an unwanted caller or message sender, nuisance block 306 may forward the number or the address to AI/ML 318 for further processing in the manner described for spam reports with reference to FIG. 9. In particular, AI/ML service 318 may correlate the nuisance caller number, the network address of the offending message, and/or the location ID 906 provided in the data obtained by nuisance block 306. After AI/ML service 318 processes the messages, operator system 324 may obtain the result of processing from AI/ML service 318. Operator system 324 may generate temporary blocking lists for particular geographical regions based on the result and send the blocking lists to subscriber service 310. Subscriber service 310 may relay them 912 to lists dB 308, for access by TAS 320 (for blocking voice calls) and/or RCS 326 (for blocking messages or other types of sessions).

FIG. 9 shows exemplary messaging between components, in system 106, which are associated with reporting spam, according to an implementation. As shown, UE 102 may report 802 voice spam or message spam to spam report service 316. Spam report service 316 may strip or exclude specific user information associated with the user of UE 102 but include the spammer number (or ID) and a location ID (e.g., a zip code, city name, etc.) to generate a message. The message may also include the text of the spam and/or additional data input by the user of UE 102 if the spam call were answered or given a fake caller ID. Next, spam report service 316 may forward the message 904 to AI/ML service 318.

AI/ML service 318 may correlate the spammer number and/or location ID 906 in the message with those of other messages. After AI/ML service 318 processes the messages, operator system 324 may obtain the result of processing 908 from AI/ML service 318. Operator system 324 may generate temporary blocking lists for particular geographical regions based on the result and send the blocking lists 910 to subscriber service 310. Subscriber service 310 may relay them 912 to lists dB 308, for access by TAS 320 and/or RCS 326.

As an example of spam reporting, assume that UE 102 in area 123 receives an SMS message stating “Please contact us before your power is turned off.” Assume that UE 102 reports the SMS message to spam report service 316. After filtering portions of the report, spam report service 316 may forward the call number, the location ID, and/or other information to AI/ML service 318. AI/ML service 318 may determine whether each reported number is likely to be a real spam by, for example, counting the number of reported messages from the same number. If the number of messages exceeds a threshold (e.g., 1000 reports), AI/ML services 318 may generate a report alerting operator system 324. After an operator at operator system 324 validates the report, the operator may generate a blocking list that includes the caller ID associated with the reported spam. Next, operator system 324 may push the updated blocking list to subscriber service 310 for storage at lists DB 308. Furthermore, subscriber service 310 may send notifications regarding the updates to voice block 302 and/or message block 304. In turn, voice block 302 and/or message block 304 may alert TASs 320 and/or RCSs 326 subscribed to the updated blocking lists. Subsequently, the TASs 320 and/or RCSs 326 may download and use the updated blocking lists.

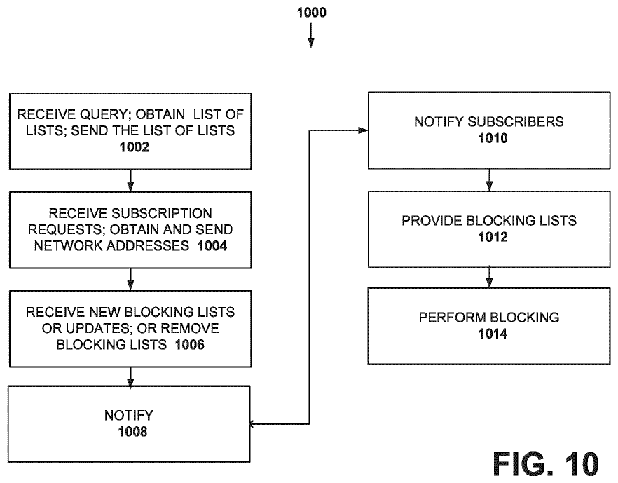

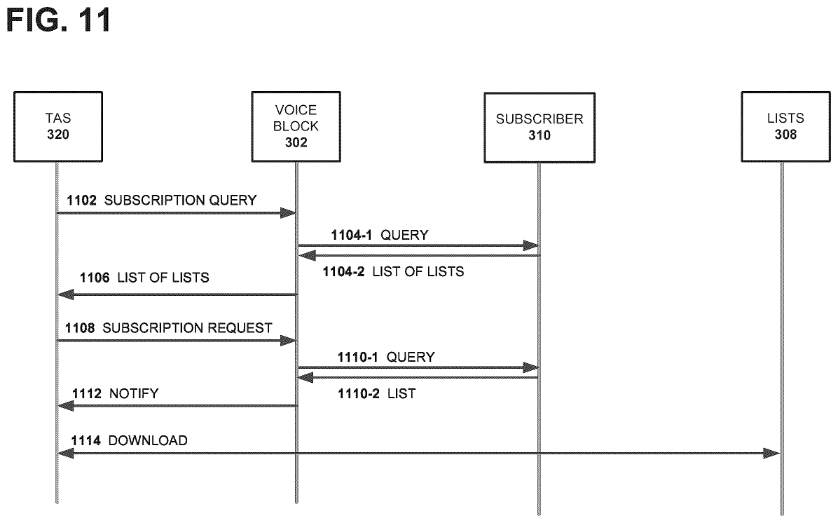

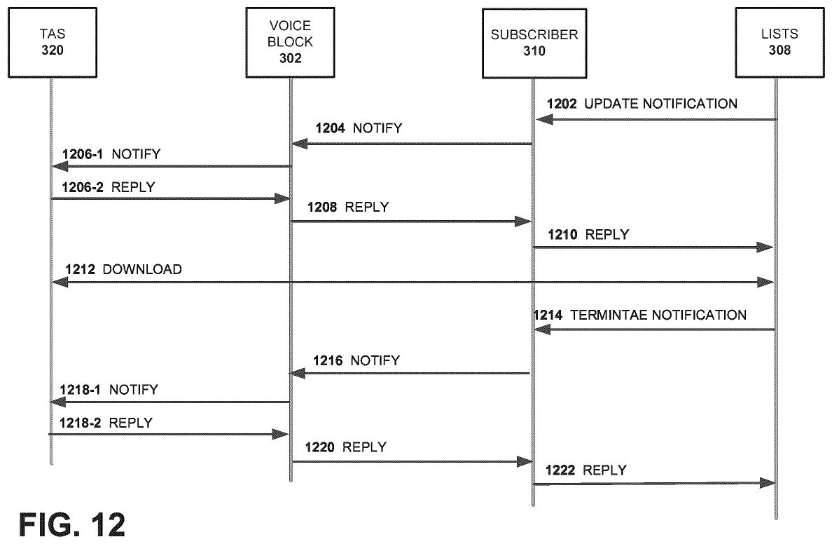

FIG. 10 is a flow diagram of an example process 1000 associated with blocking voice calls or messages, according to an implementation. FIGS. 11 and 12 depict example messages that may be exchanged between the components of system 106 during process 1000. FIGS. 11 and 12 are described below together with process 1000. Process 1000 may be performed by various components of system 106, including those depicted in FIGS. 1-3. Each block and/or arrow in FIGS. 10-12 is not intended to signify every action performed by system 106 or every message sent by system 106. For example, FIGS. 11 and 12 may not show some actions and/or messages transmitted as replies to queries or messages.

As shown, process 1000 may include a first network component receiving, from a second network component, a query about subscription (block 1002). In response to the subscription query, the first component may obtain, from a subscriber service, a list of available blocking lists (block 1002) and send the list of blocking lists to the second component (block 1002). For example, referring to FIG. 11, voice block 302 may receive a subscription query from TAS 320 (arrow 1102) and obtain a list of blocking lists from subscriber service 310 (arrows 1104-1 and 1104-2). Upon receipt of the reply from subscriber service 310, voice block 302 may send the list of blocking lists to TAS 320 (arrow 1106).

Process 1000 may further include the first component receiving one or more subscription requests from the second component (block 1004), obtaining network addresses for the blocking lists for which the subscription requests are received (block 1004), and completing the subscriptions requested by the second component, by sending the network addresses of the subscribed blocking lists to the second component (block 1004). For example, when TAS 320 receives the list of blocking lists, TAS 320 may select which of the blocking lists TAS 320 is to subscribe. Next, TAS 320 may send subscription requests for the selected blocking lists to voice block 302 (arrow 1108). When voice block 302 receives the subscription request, voice block 302 may complete the subscription of TAS 320 to the selected blocking lists, by obtaining the network addresses (e.g., URIs) that are associated with the selected blocking lists (arrows 1110-1 and 1110-2) from subscriber service 310 and send the network addresses to TAS 320 (arrow 1112). When TAS 320 receives the network addresses of the blocking lists to which TAS 320 is subscribed, TAS 320 may download the blocking lists from lists DB 308 (arrow 1114).

Process 1000 may further include lists database receiving new blocking lists, receiving updates to blocking lists, or removing blocking lists from its database (block 1006). For example, list DB 308 may store new blocking lists, delete blocking lists, and/or update blocking lists.

Process 1000 may further include the first component receiving a notification about changes to blocking lists at a lists database (block 1008). Referring to FIG. 12, for example, when lists DB 308 is updated, lists DB 308 (or a list service co-located at lists DB 308) may notify subscriber service 310 (arrow 1202), for each new, deleted, or updated blocking list (e.g., provide a name or a URI of the blocking list). When subscriber service 310 receives the notification, subscriber service 310 may send one or more notifications about the changes to voice block 302 (arrow 1204).

Process 1000 may further include the first component notifying subscribers (block 1010), which may include the second component. For example, when voice block 302 receives notification 1202 about the changes to blocking lists at lists DB 308 from subscriber service 310, voice block 302 may consult peer table 700 at voice block 302, to identify TAS 320 as the subscriber of each of the new, deleted, or updated blocking lists. Next, for each of the blocking lists, voice block 302 may send a notification about the blocking list to TAS 320 (arrow 1206-1). TAS 320 may provide a response 1206-2 to notification 1206-1; voice block 302 may provide a response 1208 to notification 1204 when voice block 302 receives response 1206-2; and subscriber service 310 may provide a response 1210 to notification 1202 when subscriber service 310 receives notification 1208. In some implementations, voice block 302 and subscriber service 310 may send responses immediately upon receipt of notifications, rather than waiting for a response to its own notification.

Process 1000 may further include lists DB 308 providing the new or updated blocking lists to the second component (block 1012) and the second component blocking communications in accordance with the provided blocking lists (block 1014). For example, TAS 320 may download 1212 the blocking lists from lists DB 308. When TAS 320 obtains the blocking lists, TAS 320 may block calls whose originating numbers are listed on the blocking lists.

If a particular notification from lists DB 308 is about a terminated blocking list, there is no need for TAS 320 to download the identified blocking list. For example, in FIG. 12, lists DB 308 sends a termination notification about a blocking list (arrow 1214). Subscriber service 310 may send a notification (arrow 1216) about the termination to voice block 302. Voice block 302 may then notify TAS 320 of the terminated blocking list (arrow 1218-1). TAS 320 may then reply 1218-2 to voice block 302; voice block 302 may reply 1220 to subscriber service 310; and subscriber service 310 may reply 1222 to lists DB 308. In this implementation or scenario, TAS 320 may not download the terminated blocking list.

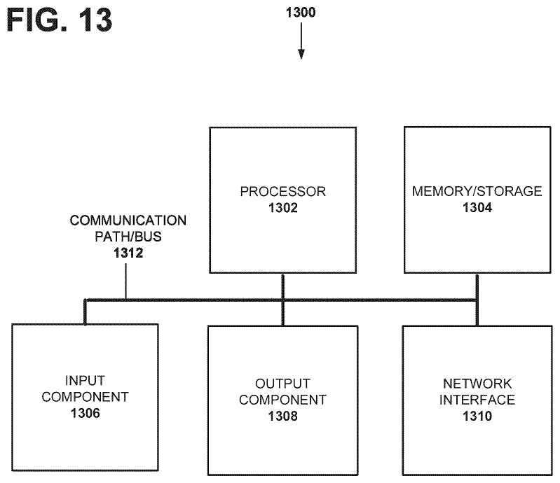

FIG. 13 depicts exemplary components of an exemplary network device 1300. Network device 1300 may correspond to or be included in any of the devices and/or components illustrated in FIGS. 1-3 (e.g., UE 102, access network 204, core network 206, data network 208, system 106, IMS 212, blocking system 300, components 302-332, etc.). In some implementations, network devices 1300 may be part of a hardware network layer on top of which other network layers and network functions (NFs) may be implemented. As shown, network device 1300 may include a processor 1302, memory/storage 1304, input component 1306, output component 1308, network interface 1310, and communication path 1312. In different implementations, network device 1300 may include additional, fewer, different, or different arrangement of components than the ones illustrated in FIG. 13. For example, network device 1300 may include line cards, switch fabrics, modems, etc.

Processor 1302 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1300 and/or executing programs/instructions.

Memory/storage 1304 may include static memory, such as read only memory (ROM), and/or dynamic memory, such as random access memory (RAM), or onboard cache, for storing data and machine-readable instructions (e.g., programs, scripts, etc.). Memory/storage 1304 may also include a floppy disk, CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1304 may be external to and/or removable from network device 1300. Memory/storage 1304 may include, for example, a Universal Serial Bus (USB) memory stick, a dongle, a hard disk, off-line storage, a Blu-Ray® disk (BD), etc. Memory/storage 1304 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1306 and output component 1308 may provide input and output from/to a user to/from network device 1300. Input/output components 1306 and 1308 may include a display screen, a keyboard, a mouse, a speaker, a microphone, a camera, a DVD reader, USB lines, and/or other types of components for obtaining, from physical events or phenomena, to and/or from signals that pertain to network device 1300.

Network interface 1310 may include a transceiver (e.g., a transmitter and a receiver) for network device 1300 to communicate with other devices and/or systems. For example, via network interface 1310, network device 1300 may communicate over a network, such as the Internet, an intranet, a terrestrial wireless network (e.g., a WLAN, WI-FI, WI-MAX, etc.), a satellite-based network, optical network, etc. Network interface 1310 may include a modem, an Ethernet interface to a LAN, and/or an interface/connection for connecting network device 1300 to other devices (e.g., a Bluetooth interface).

Communication path 1312 may provide an interface or bus through which components of network device 1300 can communicate with one another.

Network device 1300 may perform the operations described herein in response to processor 1302 executing software instructions stored in a non-transient computer-readable medium, such as memory/storage 1304. The software instructions may be read into memory/storage 1304 from another computer-readable medium or from another device via network interface 1310. The software instructions stored in memory/storage 1304, when executed by processor 1302, may cause processor 1302 to perform processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while a series of blocks, messages, and signals have been described with regard to the processes and messages illustrated in FIGS. 4, 5 and 8-12, the order of the blocks and messages may be modified in other implementations. In addition, non-dependent blocks and messages may represent actions and messages that can be performed or sent in parallel and in different order.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A system comprising:
a network device configured to:
receive a request from a communication device to subscribe to a blocking list;
subscribe the communication device to the blocking list; and
send a network identifier that is associated with the blocking list; and
the communication device configured to:
receive the network identifier;
download the blocking list based on the network identifier; and
block at least one of voice calls or messages that originate from a source identified by the blocking list.

2. The system of claim 1, wherein the network device comprises a component for providing blocking lists for blocking voice calls; and
wherein the communication device includes a Telephony Application Server (TAS).

3. The system of claim 2, wherein the TAS is configured to:
obtain a list of nuisance callers from a provisioning server device hosting a subscription profile that is associated with a User Equipment device (UE); and
use the list of nuisance callers to block voice calls from sources identified by the list of nuisance callers.

4. The system of claim 3, wherein the provisioning server device includes:
a Home Subscriber Server (HSS) device;
a Unified Data Management (UDM) device; or
a Unified Data Repository (UDR).

5. The system of claim 3, wherein the system further comprises:
a nuisance server device for obtaining the list of nuisance callers from the UE and providing the list of nuisance callers to the provisioning server device for storage in the subscription profile.

6. The system of claim 1, wherein the network device comprises a component for providing blocking lists for blocking messages; and
wherein the communication device includes a Rich Communication Services (RCS) device.

7. The system of claim 6, wherein the RCS device is configured to:
instruct a Serving-Call Session Control Function (S-CSCF) device to block messages originating from sources identified by the blocking list.

8. The system of claim 1, further comprising a component configured to:
collect spam reports from User Equipment devices (UEs);
process the spam reports; and
send the processed reports to another network component for generating a new blocking list based on the processed reports.

9. The system of claim 8, wherein the other network component includes an Artificial Intelligence/Machine Learning (AI/ML) component that applies a threshold to identify sources whose number of spam reports exceed the threshold.

10. The system of claim 1, wherein the blocking list includes an expiration time at which the communication device no longer blocks particular voice calls or messages.

11. A method comprising:
receiving, by a network device, a request from a communication device to subscribe to a blocking list;
subscribing, by the network device, the communication device to the blocking list;
sending, by the network device, a network identifier that is associated with the blocking list to the communication device;
downloading, by the communication device, the blocking list based on the network identifier; and
blocking, by the communication device, at least one of voice calls or messages that originate from a source identified by the blocking list.

12. The method of claim 11, wherein the network device comprises a component for providing blocking lists for blocking voice calls; and
wherein the communication device includes a Telephony Application Server (TAS).

13. The method of claim 12, further comprising:
obtaining, by the TAS, a list of nuisance callers from a provisioning server device hosting a subscription profile that is associated with a User Equipment device (UE); and
using, by the TAS, the list of nuisance callers to block voice calls from sources identified by the list of nuisance callers.

14. The method of claim 13, wherein the provisioning server device includes:
a Home Subscriber Server (HSS) device;
a Unified Data Management (UDM) device; or
a Unified Data Repository (UDR).

15. The method of claim 13, further comprising:
obtaining, by a nuisance server device, the list of nuisance callers from the UE; and
providing, by the nuisance server device, the list of nuisance callers to the provisioning server device for storage in the subscription profile.

16. The method of claim 11, wherein the network device comprises a component for providing blocking lists for blocking messages; and
wherein the communication device includes a Rich Communication Services (RCS) device.

17. The method of claim 16, further comprising:
instructing, by the RCS device, a Serving-Call Session Control Function (S-CSCF) device to block messages originating from sources identified by the blocking list.

18. The method of claim 11, further comprising:
collecting, by a network component, spam reports from User Equipment devices (UEs);
processing, by the network component, the spam reports; and
sending, by the network component, the processed reports to another network component for generating a new blocking list based on the processed reports.

19. The method of claim 18, wherein the other network component includes an Artificial Intelligence/Machine Learning (AI/ML) component that applies a threshold to identify sources whose number of spam reports exceed the threshold.

20. A non-transitory computer-readable medium comprising processor-executable instruction, which when executed by one or more processors of a network device and a communication device, cause the one or more processors to:
receive, by the network device, a request from a communication device to subscribe to a blocking list;
subscribe, by the network device, the communication device to the blocking list;
send, by the network device, a network identifier that is associated with the blocking list;
receive, by the communication device, the network identifier from the network device;
download, by the communication device, the blocking list from a location identified by the network identifier; and
block, by the communication device, at least one of voice calls or messages that originate from a source identified by the blocking list.
